(19) United States
(12) Patent Application Publication
(10) Pub. No.: US 2015/0353009 A1
(43) Pub. Date: Dec. 10, 2015

(54) DRIVE ASSISTANCE DEVICE FOR MOTOR VEHICLES

(71) Applicant: BREVETTI LAB S.R.L., Roma (IT)

(72) Inventor: Fabio LETTIERI, Basiglio (IT)

(21) Appl. No.: 14/762,461

(22) PCT Filed: Jan. 8, 2014
(86) PCT No.: PCT/IB2014/058128

§ 371 Date: Jul. 21, 2015

(30) Foreign Application Priority Data
Jan. 21, 2013 (IT) MO2013A000012

(51) Int. Cl. B60Q 9/00; G01S 17/93

(52) U.S. Cl. CPC B60Q 9/008; G01S 17/936

(57) ABSTRACT

The device (1) for aiding the driving of a motor vehicle (2) comprises: infra-red means (3, 4) to detect the presence of possible obstacles outside the motor vehicle (2); a processing unit (5) connected to the infra-red means (3, 4) and able to determine the distance of the device (1) from the obstacles detected by the infra-red means (3, 4); signalling means connected to the processing unit (5) and able to signal to a driver of the motor vehicle (2) the presence of obstacles arranged within a predetermined distance from the device (1); and securing means (7) to secure the device (1) within the inside compartment of the motor vehicle (2).

### TECHNICAL FIELD

The present invention relates to device for aiding the driving of motor vehicles, particularly intended for parking aid.

### BACKGROUND ART

Parking aid systems are known, ready fitted on board motor cars, and designed to warn the driver by means of acoustic or visual signals of the presence and nearness of possible obstacles to parking operations.

One known type of system is that which employs ultrasonic proximity detectors, integrated in the front and/or rear bumpers.

The operation of this type of detector is based on the measurement of the reflection time of the sound pulses emitted and detected by it.

This system can be fitted on the vehicle during its manufacture, i.e., before purchase, or can be installed on it after purchase, using specific kits marketed by the flourishing automobile aftermarket industry.

In this latter case, the fitting of the system requires the intervention of a skilled technician, who makes specific holes in the bumpers, in order to house the detectors, which have to be connected to the vehicle control unit, to ensure the system only operates when the reverse gear has been engaged, and to ensure it is supplied by the battery of the vehicle itself.

Other drawbacks of this known system are those presented below.

Considering the system is based on the reflection of sound waves, it is not very efficient in detecting some types of small obstacles or which are not flat such as, e.g., a thin pole or an elongated object pointing towards the vehicle, etc. . . . .

Since the detectors are fitted in the bumpers, it is clear that, in the event of a collision, they are very likely to be damaged.

Furthermore, the detectors must directly access the outside of the vehicle and therefore be exposed to weather conditions which makes likely their replacement before the end of the life cycle of the motor vehicle, with the consequent doubling of costs.

Another type of system is that based on the emission of radio waves, and the detection of the relative echoes coming from the obstacles present within their range of action.

Such system, in point of fact, comprises sensors using the same operating principle as the radar.

Such sensors are normally arranged in correspondence to the inner surfaces of the bumpers and, consequently, although their installation does not damage and does not change the appearance of the bumpers, nevertheless it requires them to be removed and refitted by expert personnel which is therefore time consuming and costly.

This system too is connected, albeit indirectly, to the control unit, for the purposes of power supply.

A further and significant drawback of such known system is that its operation is based on radio waves, which can cause interferences with other electromagnetic devices in the proximity of the vehicle, thus causing false positives or even harmful interferences with the vehicle on-board electronics.

### DESCRIPTION OF THE INVENTION

The main aim of the present invention is to provide a device for aiding the driving of a motor vehicle which is not subject to the wearing action of the weather and which does not interfere with the electronic devices present on the motor vehicle or carried by the driver or by passengers.

Within this aim, one object of the present invention is to provide a driving-aid device which may be installed on any motor vehicle.

A further object of the present invention is to provide a driving-aid device, installable on a motor vehicle without the need for skilled labour, and without having to damage or remove components of the bodywork of the vehicle itself.

Another object of the present invention is to provide a portable and independent driving-aid device which represents a functional block in itself and which can therefore be installed as required on any motor vehicle.

Yet another object of the present invention is to provide a parking-aid device, without the need to be connected to the vehicle control unit on which it is applied and that allows overcoming the aforementioned drawbacks of the state of the art within the scope of a simple and rational solution that is easy and effective to use and which is inexpensive.

The above mentioned objects are achieved by the present device for aiding the driving of a motor vehicle, according to the claim 1.

### BRIEF DESCRIPTION OF THE DRAWINGS

Other characteristics and advantages of the present invention will appear more evident from the description of a preferred, but not sole embodiment, of a driving-aid device, illustrated in an exemplary but not restrictive way on the attached drawing tables wherein:

FIG. 1 is a schematic front view of the driving-aid device according to the invention;

FIG. 2 is a schematic axonometric view of a vehicle on which is installed the device according to the invention; and

FIG. 3 is a bloc diagram which shows the overall functional units of the device according to the invention.

### EMBODIMENTS OF THE INVENTION

With particular reference to such illustrations, globally indicated by 1 is the device for aiding the driving of a motor vehicle 2.

In its more general aspects, the device 1 comprises, first of all, infra-red means 3, 4 to detect the presence of possible obstacles outside the motor vehicle 2.

Furthermore, the proposed device 1 comprises a processing unit 5 (which includes, e.g., a micro controller) connected to the infra-red means 3, 4 and able to determine the distance of the device 1 itself from the obstacles detected by the infra-red means (so as to be able to assess the distance of the motor vehicle 2 from the obstacles).

The invention also provides for both signalling means connected to the processing unit 5, and able to signal to the driver the presence of obstacles arranged within a predetermined distance from the device 1, and securing means for securing the device in a removable way within the inside compartment of the motor vehicle 2.

Before describing in detail the main embodiments of the invention and illustrating their advantages, an explanation is provided below of how this achieves some of the preset objects.

First of all, considering the proposed device 1 uses an infra-red technology to detect obstacles present in the environment surrounding the vehicle 2, then it is able to completely overcome the problem of the interferences caused by the known devices which make use of electromagnetic radiation in the spectrum of radio frequency.

Furthermore, the device 1 is available within the inside compartment of the vehicle 2 which, as will be better explained later on during the description of the main embodiments of the invention, is synergic with the fact of providing infra-red detection means 3, 4, because the emitted and received radiations in the infra-red range are able to pass through the windows of the vehicle, thereby allowing the perfect operation of the device 1 itself.

Considering the device 1 is able to assist the driver, provided it is arranged inside the vehicle compartment, then it is completely protected from weather conditions and does not require, for its installation, either drilling or removing and refitting the bumpers or other parts of the bodywork of the vehicle 2.

Consequently, the implementation of the device 1 on the vehicle 2 does not necessarily require the use of skilled labour, hence a big saving in terms of costs, just as it does not require complicated and awkward fitting/removal procedures, to the full advantage of speed and convenience of application.

Below, two main embodiments of the invention will be described, the first of which relates to a device 1 designed particularly for use as a parking aid, while the second relates to a device 1 able to assist driving in case of foggy weather.

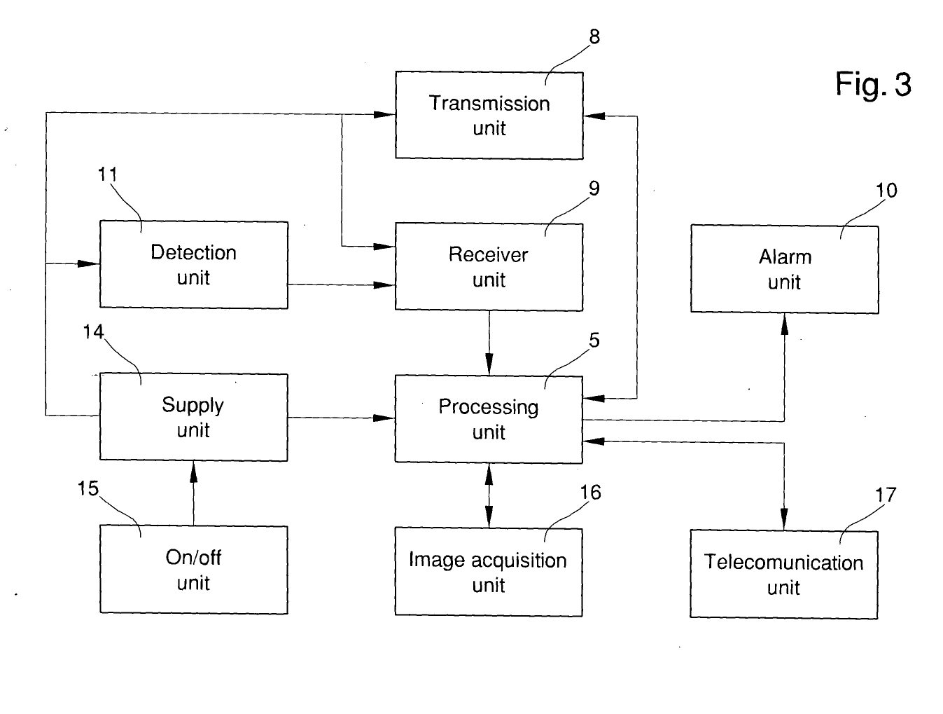

The device of the first embodiment 1 includes at least five main operating units (see FIG. 3): the aforementioned processing unit 5, which can comprise the above micro controller; a transmission unit 8, which comprises at least an infra-red radiation emitter 3 (but preferably a plurality, for reasons detailed in a subsequent paragraph), such as, e.g., an infra-red LED (light emission diode); a receiver unit 9, which includes receiver means 4 (e.g., at least one infra-red receiver) to detect infra-red radiation reflected off obstacles; an alarm unit 10, which includes said signalling means; and a detection unit 11, which can comprise means of direction (such as, e.g., a triaxial accelerometer or a thermopile) for setting the direction of movement of the motor vehicle 2, connected to the micro controller in such a way that this triggers the emitter 3 and the signalling means, following the movement manoeuvre of the motor vehicle 2 in a predetermined direction of movement.

Usefully, each infra-red radiation emitter 3 and/or each of the receiver means 4 can be provided with suitable lenses and/or further optical or optoelectronic devices able to extend and/or change the area covered by the infra-red radiation. As said, and illustrated in the attached FIG. 2, the device 1 of this embodiment has been conceived, in particular, to be placed in correspondence to the inner surface of the rear window 6 of the motor vehicle 2, by means of the aforementioned securing means, which preferably comprise elements able to produce a removable blockage of the windows of a car 2, such as, e.g., suction cups 7 or the like.

In particular, the securing means can also include manual calibration means, conceived so as to correctly direct the infra-red means 3, 4 of the invention.

In fact, for the purposes of the better effectiveness of the device 1, it is preferable for the infra-red radiation to be always directed towards the ground, with a point of ground impact located, e.g., between 1.5 and 3 metres from the vehicle itself.

The invention has been conceived to be installed on different types of motor vehicles, having different types of rear windows, and consequently, the best inclination of the infra-red radiation is not an absolute datum but depends on the specific vehicle on which the device is installed (think for example of a coupe car).

Advantageously, the device 1 can include the aforementioned manual calibration means for the purpose of making sure that, whatever the type of vehicle 2 on which the invention is installed, the inclination of the infra-red radiation is always the best.

In particular, in one of their possible versions, the manual calibration means include a rotation shaft, designed to be arranged horizontally, such shaft being partially included within the casing 12 of the device 1, with respect to which it is rotatable, and is arranged substantially parallel with the length extension of the casing 12.

On the shaft are keyed the infra-red means 3, 4 of the invention, and on it is also mounted a light device, able to produce a guiding light beam, in the visible spectrum, and such device can include a laser pointer or a light diode or the like. The light device can be started by the movement of the shaft or by means of a special button, and can be stopped after a preset time interval.

The shaft, for example, can be operated in rotation by the user by means of a special knob which purposely protrudes from the casing 12, which, in use, is fastened to the window 6.

In practice, the user operates the knob until the guiding light beam cuts the ground at the desired distance from the vehicle 2 (e.g., as said, between 1.5 and 3 metres).

Consequently, by means of a very simple manual adjustment, the device 1 always provides good performances even in the presence of vehicles with very angled rear window or having a very protruding “tail end”.

In addition, the above manual calibration means allow the user to personalize the use of the proposed device 1 according to his/her own particular needs.

With reference to a different possible version of the device 1, the shaft can be associated with automatic calibration means for automatically calibrating the inclination of each infra-red radiation emitter 3, according to the inclination of the rear window of the vehicle on which the device itself is installed.

In particular, in this version of the invention, the automatic calibration means comprise a software program for the self-calibration of the device 1, present in the processing unit 5 and able to estimate the best angle of inclination of the transmitters, operatively connected to a suitable inclination sensor able to detect the inclination of the window.

The software consequently modifies the inclination of each infra-red radiation emitter 3 with respect to the ground, depending on the inclination of the window determined by the inclination sensor.

For example, such inclination sensor can consist of the same means of direction previously described or, alternatively, of a specifically dedicated sensor.

It should be noted that, in the present description, by “windows” of the inside compartment or of the vehicle 2, is meant the windshield, the back window or even the side windows.

The means of direction is configured so as to signal to the micro controller whether the vehicle 2 is moving in reverse, while the suction cups 7, the LEDs 3 and the receiver means 4 are arranged, the one with respect to the other, in such a way that, following the securing of the device 1 to the rear window 6, the LEDs 3 and the receiver means 4 are facing the rear window 6 itself so as to be able to detect obstacles positioned beyond it, outside the motor vehicle 2,

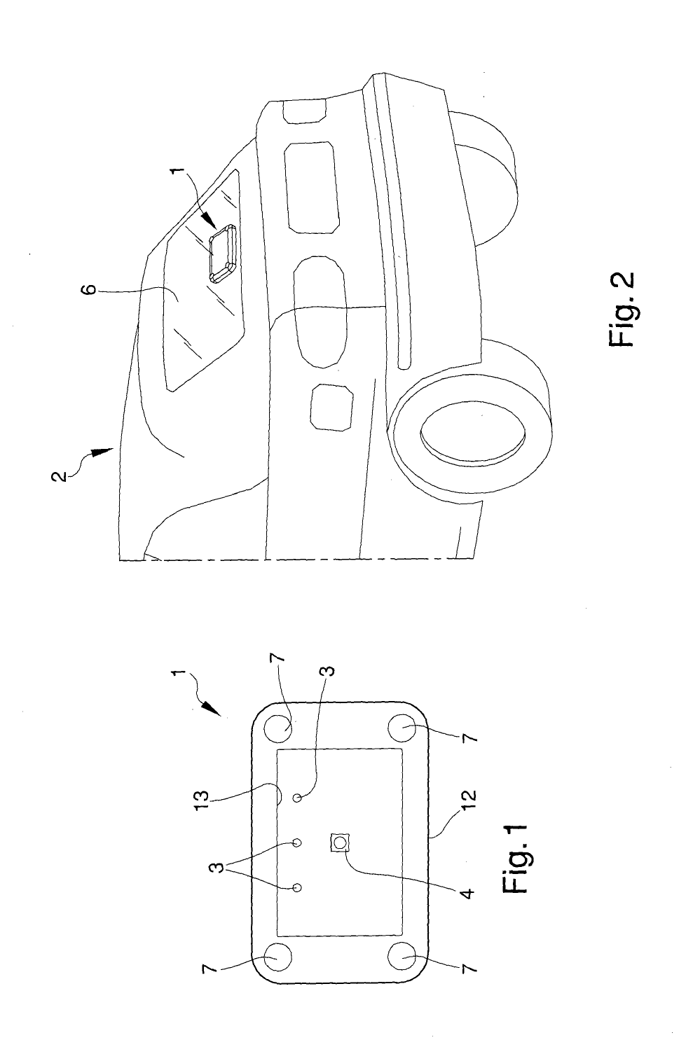

In particular, in the example illustrated in the FIGS. 1 and 2, the device comprises a casing 12, wherein are included all the aforementioned units 5, 8, 9, 10, 11.

The casing 12, which can have a parallelepiped shape, for example has, in correspondence to one of its sides or faces, a window 13 (closed for example by a transparent plastic wall, e.g., polymethylcrylate) through which the infra-red means 3, 4 face outwards, on the same side being arranged the aforementioned suction cups 7 (preferably in correspondence or in the proximity of the corners of such side), so that, once the device 1 has been fitted to the rear window 6, its infra-red means 3, 4 can “see”-outside the inside compartment (with the correct inclination provided by the aforementioned calibration instrument).

In practice, when the motor vehicle 2 starts to move in reverse, the micro controller, warned by the means of direction, activates the LEDs 3, which begin transmitting infra-red radiation (in the form of pulses) beyond the rear window 6.

If the transmitted radiation reaches an obstacle (e.g., another motor vehicle or a public lamp pole, or the like), it is reflected and reaches the receiver means 4 which are connected to the micro controller, which calculates the distance from the obstacle and, if such distance is the same or less than a preset limit, activates the alarm unit so that the signalling means warn the driver of the dangerous proximity of the obstacle, e.g., by means of acoustic signals (and/or light signals) of increasing intensity and/or frequency as the obstacle comes nearer to the device 1 (and therefore to the vehicle 2).

The transmission unit 8 can include piloting means for controlling the transmission mode of the pulses by the LEDs 3, thereby establishing their so-called useful work cycle (or duty cycle), and such piloting means can be of the known type, as long as they are suitable for the purpose.

The piloting means, like the other units of the device 1, are naturally connected to a power supply, preferably made up of a supply unit 14 included in the device 1 itself (the peculiarities of which will be explained later on) and therefore, such piloting means are placed between the power supply and the LEDs 3, so as to pilot the latter for the purpose of determining their pulsation.

Advantageously, because the proposed device 1 detects the direction of movement by means of a means of direction, and not by means of a connection to the control unit, it is able to operate perfectly even when the vehicle 2 is moving in reverse in idle gear due to a gradient or inertia.

Preferably, the processing unit 5 has a signal numerical processing logic (including but not limited to a Kalman filter) which is able to obtain the speed direction from the data provided by the means of direction, whether or not the driver successively accelerates or decelerates while the vehicle 2 moves in reverse, thus fully eliminating the need to connect the processing unit 5 to the control unit of the car 2.

Furthermore, according to a preferred aspect of the invention, the micro controller is programmed in such a way that, when the direction means detects a reversal of the speed direction, i.e., when it detects that the vehicle is moving forwards, then the micro controller moves the device 1 to low-consumption mode, switching off all the functional units except the detection unit which contains the means of direction (so as to be able to detect when the vehicle 2 again moves in reverse, when all the function units are reactivated).

Preferably, as has been said, the device 1 includes a plurality of LEDs 3, e.g., three or five, arranged on a line at respective and preset distances from the receiver means 4.

In this case, such LEDs 3 can be controlled (by the aforementioned piloting means) in such a way that each emits pulses at a frequency different from those transmitted by the others, while the micro controller is programmable so as to determine from which of the LEDs 3 the reflected radiation, which is from time to time detected by the receiver means 4, has been transmitted.

This solution can be useful, e.g., in the case of installation on vehicles having at the rear a boot which protrudes from the rear window 6 to a no small extent or, in any case, parts of the bodywork or other components integral with the vehicle, which will be affected by the infra-red pulses emitted by the device 1, once secured to the rear window 6, and will reflect such pulses to the receiver means, even though they do not have to be “recognised” as obstacles by the micro controller.

In this case, during the installation phase of the device 1 on the vehicle 2, the micro controller can be programmed to “ignore” that series of pulses which has reached the receiver means 4 after being reflected off a surface which must not be classified as an obstacle; this is permitted because, as has been said, the emitters 3 transmit infra-red radiations with an own specific pulse frequency.

Furthermore, the receiver unit 9 can comprise conditioning circuits, connected to the receiver means 4, which are configured so that, according to the power of the radiation emitted by the LEDs 3, the receiver unit 9 itself is able to distinguish the infra-red pulses reflected by an obstacle from the electromagnetic radiation of the natural and artificial lighting present in the environment surrounding the vehicle.

According to a possible but not exclusive embodiment, as shown in FIG. 1, the receiver means 4 include one or more receivers 4 arranged at the centre of the aforementioned window 13 (e.g., in a row), while the row of emitters 3 is arranged in the upper half of the window itself, e.g., parallel with the longer sides of same, in the event of its being rectangular, and horizontal during use.

As has been said, advantageously, the infra-red means 3, 4, the processing unit and the signalling means (and the other components optionally included in the device) are comprised in the same casing 12, to which are fastened the securing means 7, to define a unitary and independent functional block which is portable and can therefore be fitted to (and removed from) different vehicles 2, requiring neither changes to the bodywork nor the removal/fitting of parts of the bodywork itself.

In particular, the perfect independence of the device 1 of the invention is ensured by the fact that it also comprises the aforementioned supply unit 14 to supply the other above-mentioned units, included in the casing 12, and this is yet another of the reasons why the invention does not need connecting to the control unit of the vehicle 2.

In detail, the supply unit 14 preferably comprises a rechargeable battery, a (acoustic and/or visual) down battery indicator system a supply unit and a “step-down” converter.

The device 1 can be accompanied by an external supply unit, connectable in a releasable way to the supply unit 14, for the purpose of both recharging the battery and associating with an external supply unit, such as the cigarette-lighter of the vehicle 2, in which case the external supply unit will have a cable with a specific connection jack.

In addition or alternatively, the perfect independence of the device 1 can be ensured by the fact that the supply unit includes at least a photovoltaic module, fitted on the casing 12 so as to be able to receive solar radiations.

In particular, it is specified that the usable photovoltaic module can be made using any photovoltaic technology (photovoltaic panels, flexible systems, spherical concentrator systems, etc.) and not necessarily made by means of a traditional photovoltaic module of the rigid type.

On the side, or face, of the casing 12 opposite that on which the aforementioned window 13 is obtained, an on/off button and a LED can be arranged to signal whether the device 1 is on or off and these represent an on/off unit 15 of the invention (again see FIG. 3).

Optionally, the device can comprise means for the acquisition of images (such as a camera) connected to the processing unit 5.

Such acquisition means, together with the relative memorization means connected to them, e.g., of the EEPROM type, can make up an image acquisition unit 16 integrated in the device 1.

In this case, preferably, the device 1 also includes a telecommunication unit 17, connected to the processing unit 5, and able, e.g., to connect itself to mobile communication means, such as smartphones, or other similar devices (tablet, padphone, smart CD and smart TV, etc.) on which to display the images acquired by the camera.

In this case, such function can be started by means of suitable software commands available on specific applications present on the smartphone or on any other similar remote device.

A further advantage of the invention with respect to known parking aid systems, is that, because of its particular collocation in correspondence to the rear window 6, it is able to detect obstacles arranged at a greater height, compared to those identified by known systems, the latter being fitted in the bumpers to check whether, around the vehicle, there are any objects substantially arranged in the proximity of the ground.

The aforementioned second embodiment of the invention, described below, comprises all the optional and non-optional elements of the first embodiment, unless otherwise specified below.

In this second embodiment, the device 1 is particularly designed to be arranged in correspondence to the internal surface of the windshield of a vehicle 2, with the infra-red means 3, 4 which are turned in the front direction of the vehicle 2 itself.

The main object of this second embodiment is to assist the driver during driving when the weather is foggy.

Consequently, preferably, the aforementioned series of infra-red emitters comprises at least five LEDs to define a sort of infra-red radar which scans the area in front of the vehicle 2, so as to signal to the driver, always by means of the alarm unit 10, when he/she is too close to other vehicles or other possible obstacles present in front of the vehicle 2, that could be hidden from the driver's view by fog.

The operation of the second embodiment of the proposed device 1 is like that of the first embodiment except that, preferably, its activation is not subject to a detection unit comprising an accelerometer or other means of direction, being in this case more comfortable and functional that the infra-red means 3, 4 and the other components of the device are automatically started following the start of the device itself by the driver, by means of the above-mentioned on/off unit.

It should be noticed that, preferably, the invention can work in both “stand alone” mode, i.e., not connected to any other device, and, e.g., interfaced by means of a wireless channel with a smartphone or any other similar device.

In the event of the invention being used in stand-alone mode, the device can switch from the configuration of the first embodiment to that of the second embodiment, by means of a specific micro switch (or other similar means), which permits choosing between the parking function or the driving aid function.

In the event of the invention being used in connection with a smartphone or any other similar device, the switch of configuration will be commanded via software by means of specific applications present on the smartphone.

Now coming back to the description of the second embodiment, in place of or alongside the above-mentioned camera, there can be an infra-red camera, arranged in the image acquisition unit 16, which is able to detect, in particular, the heat of the engines or of the indicator lights of the vehicles in front of the motor vehicle on which the proposed device 1 is installed.

Such infra-red camera is also connected to the processing unit 5 which, in this case as well, is preferably connected to the telecommunication unit 17 so the acquired images are sent to a mobile device or to the computer on board the vehicle 2, so as to provide complete driving assistance in case of fog.

Always with reference to the specific embodiment of the device 1 able to allow driving aid in case of limited visibility, an auxiliary infra-red lighting system could be present, to be installed inside or outside the vehicle which, without any need for interfacing with the invention, permits extending the range of vision of the camera described above.

It has in point of fact been ascertained how the invention achieves the proposed objects and in particular the fact is underlined that it makes available a device 1 for aiding the driving which, when used as a parking aid, offers better performance than known systems, and which has been designed in such a way as to be able to assist driving in case of foggy weather.

1-17. (canceled)

18. A device for aiding the driving of a motor vehicle, comprising:
an infra-red means to detect a presence of a possible obstacle outside the motor vehicle;
a processing unit connected to said infra-red means and suitable for determining a distance of said device from said obstacle detected by said infra-red means;
a signaling means connected to said processing unit and suitable for signaling to a driver of said motor vehicle the presence of obstacles arranged within a predetermined distance from said device; and
a securing means to secure said device within an inside compartment of said motor vehicle.

19. The device according to claim 18, where said securing means are suitable for securing said device in a removable way to a glass of said inside compartment.

20. The device according to claim 19, where said securing means and said infra-red means are arranged the one with respect to the other in such a way that, following the securing of said device to said glass, said infra-red means are facing said glass so as to be able to detect obstacles positioned beyond it, outside said motor vehicle.

21. The device according to claim 18, where said infra-red means comprise at least an infra-red radiation emitter and receiver means to detect infra-red radiation reflected off said obstacles.

22. The device according to claim 21, comprising a plurality of infra-red radiation emitters are controlled in such a way that each emits a series of pulses at a frequency different from those transmitted by the other emitters and by the fact that said processing unit is programmable to determine from which emitter said reflected radiation, which is from time to time detected by said receiver means, has been transmitted.

23. The device according to claim 18, comprising a rechargeable supply unit, connected to said infra-red means, to said processing unit and to said signaling means.

24. The device according to claim 18, where said infra-red means, said processing unit, and said signaling means are comprised in a same casing to which are fastened said securing means, to define a unitary and independent functional block.

25. The device according to claim 18, comprising means for the acquisition of images connected to said processing unit.

26. The device according to claim 18, comprising means of direction to set the direction of movement of said motor vehicle, connected to said processing unit in such a way that this triggers said infra-red means and said signaling means, following the movement maneuver of the motor vehicle in a predetermined direction of movement, said device being secured to the inner surface of a rear window of said motor vehicle, to define a parking-aid device.

27. The device according to claim 26, characterized by the fact that said means of direction comprise at least one accelerometer.

28. The device according to claim 21, where that said infra-red radiation emitter and/or said receiver means comprise at least a lens and/or an optical or optoelectronic device able to extend and/or change the area covered by the infra-red radiation.

29. The device according to claim 18, comprising a manual calibration means for manually calibrating the inclination of said infra-red means.

30. The device according to claim 18, comprising an automatic calibration means for automatically calibrating the inclination of said infra-red means, according to the inclination of said window of the vehicle on which the device itself is installed.

31. The device according to claim 29, where said manual calibration means comprises at least a rotation and supporting shaft of said infra-red means, said shaft being operated in rotation for the adjustment of the inclination of said infra-red means.

32. The device according to claim 30, where said automatic calibration means comprises at least a rotation and supporting shaft of said infra-red means, said shaft being operated in rotation for the adjustment of the inclination of said infra-red means.

33. The device according to claim 30, where said automatic calibration means comprise at least an inclination sensor able to detect the inclination of said window.

34. The device according to claim 30, where said automatic calibration means comprise at least a software program operatively connected to said inclination sensor and able to estimate the best angle of inclination of said infra-red means.

35. The device according to claim 18, comprising at least an auxiliary infra-red lighting system able to extend the range of vision of said means for the acquisition of images.
